(19) United States
(12) Patent Application Publication
(10) Pub. No.: US 2026/0251773 A1
(43) Pub. Date: Aug. 27, 2026

(54) RADAR APPARATUS AND METHOD OF OPERATING RADAR APPARATUS

(71) Applicant: Mitsubishi Electric Corporation, Tokyo (JP)

(72) Inventors: Tatsuya KAMIMURA, Tokyo (JP); Tatsuya HAGIWARA, Tokyo (JP)

(73) Assignee: Mitsubishi Electric Corporation, Tokyo (JP)

(21) Appl. No.: 18/874,599

(22) PCT Filed: Jun. 24, 2022
(86) PCT No.: PCT/JP2022/025348

§ 371 Date: Dec. 13, 2024

(51) Int. Cl. G01S 13/58; G01S 7/03; G01S 7/35; G01S 7/40; G01S 13/931

(52) U.S. Cl. CPC G01S 13/584; G01S 7/03; G01S 7/356; G01S 7/4013; G01S 7/4021; G01S 13/931

(57) ABSTRACT

In a radar apparatus, a signal processing unit that performs object detection processing includes R-FFT units, V-FFT units, an A-FFT unit, a transmission phase control unit, a reception phase reference value storage unit, and a reception phase correction unit. The transmission phase control unit modulates the transmission phases of transmission chirp signals with different degrees of modulation for individual transmitting channels. The reception phase reference value storage unit holds reception phase reference values that are reception phase information. The reception phase correction unit calculates the amounts of change in reception phases, based on the reception phases in spectra obtained by the R-FFT units and the V-FFT units, and the reception phase reference values stored in the reception phase reference value storage unit, and reflects the calculated amounts of change onto processing by the A-FFT unit.

### FIELD

The present disclosure relates to a radar apparatus for detecting objects and a method of operating the radar apparatus.

### BACKGROUND

Patent Literature 1 below discloses a radar apparatus that receives direct waves radiated from a transmitting circuit and coupled directly not via an object, so as to be able to perform failure detection during operation without using reflected waves from an object. Such radar apparatuses have already been used as radar apparatuses for automobile sensors.

### CITATION LIST

### Patent Literature

Patent Literature 1: WO 2019/234946 A

### SUMMARY OF INVENTION

### Problem to be Solved by the Invention

Radar apparatuses for automobile sensors typically include, in addition to an object detection mode for detecting information on objects, other operation modes such as a failure detection mode and a performance correction mode. Such radar apparatuses including a plurality of operation modes are increased in operating time and disadvantageously take a longer time for failure determination of the radar apparatuses.

The present disclosure has been made in view of the above. It is an object of the present disclosure to provide a radar apparatus that can prevent an increase in the time required for failure determination of the radar apparatus even including a plurality of operation modes.

### Means to Solve the Problem

In order to solve the above-described problem and achieve the object, a radar apparatus according to the present disclosure includes a plurality of transmitting channels that generate transmission chirp signals, and a plurality of receiving channels that receive reflected waves of the transmission chirp signals radiated from the transmitting channels and reflected at an object, and mix received signals using a reference signal on which the transmission chirp signals are based. The radar apparatus also includes a signal processing unit that performs detection processing on the object, based on beat signals mixed by the receiving channels. The signal processing unit includes first and second processing units, a transmission phase control unit, a storage unit, and a reception phase correction unit. The first processing unit detects the position and the velocity of the object, based on the beat signals. The second processing unit detects the azimuth angle of the object, based on the beat signals and the results of processing by the first processing unit. The transmission phase control unit modulates the transmission phases of the transmission chirp signals with different degrees of modulation for the individual transmitting channels. The storage unit holds reception phase reference values that are reception phase information. The reception phase correction unit calculates the amounts of change in reception phases, based on the reception phases in spectra obtained by the first processing unit and the reception phase reference values held in the storage unit, and reflects the calculated amounts of change onto processing by the second processing unit.

### Effects of the Invention

The radar apparatus according to the present disclosure has an advantage of being able to prevent an increase in the time required for failure determination of the radar apparatus even including a plurality of operation modes.

### BRIEF DESCRIPTION OF DRAWINGS

FIG. 1 is a block diagram illustrating an exemplary configuration of a radar apparatus according to a first embodiment.

FIG. 2 is a diagram illustrating a first example of time waveforms of a transmission frequency and transmission phases in a failure detection mode in the first embodiment.

FIG. 3 is a diagram illustrating a second example of time waveforms of the transmission frequency and the transmission phases in the failure detection mode in the first embodiment.

FIG. 4 is a diagram illustrating spectral results of received data in any one receiving channel corresponding to the waveforms illustrated in FIG. 2.

FIG. 5 is a diagram illustrating spectral results of received data in any one receiving channel corresponding to the waveforms illustrated in FIG. 3.

FIG. 6 is a flowchart for explaining operations in the failure detection mode by a failure detection unit and a reception phase correction mode by a reception phase correction unit in the first embodiment.

FIG. 7 is a diagram for explaining a method of calculating the amounts of reception phase change in the reception phase correction mode in the first embodiment.

FIG. 8 is a block diagram illustrating an example of a hardware configuration that implements functions of a signal processing unit in the first embodiment.

FIG. 9 is a block diagram illustrating another example of a hardware configuration that implements the functions of the signal processing unit in the first embodiment.

FIG. 10 is a block diagram illustrating a configuration of a radar apparatus according to a second embodiment.

FIG. 11 is a flowchart for explaining operations in a failure detection mode by a failure detection unit and a transmission amplitude correction mode by a transmission amplitude correction unit in the second embodiment.

FIG. 12 is a diagram for explaining a method of calculating the amounts of transmission amplitude change in the transmission amplitude correction mode in the second embodiment.

FIG. 13 is a block diagram illustrating a configuration of a radar apparatus according to a third embodiment.

FIG. 14 is a flowchart for explaining operations in a failure detection mode by a failure detection unit and a transmission phase correction mode by a transmission phase correction unit in the third embodiment.

FIG. 15 is a diagram for explaining a method of calculating the amounts of transmission phase change in the transmission phase correction mode in the third embodiment.

### DESCRIPTION OF EMBODIMENTS

Hereinafter, a radar apparatus and a method of operating the radar apparatus according to embodiments of the present disclosure will be described in detail with reference to the accompanying drawings. The following embodiments will be described with a radar apparatus for an automobile sensor installed on an automobile as an example, which is not intended to exclude application to other uses. In the following description, a plurality of components of the same type are denoted by a reference numeral with subscripts. However, when the individual components are not distinguished from each other, the notation of the subscripts is omitted as appropriate. In the following description, physical connection and electrical connection are simply referred to as “connection” without distinction. That is, the term “connection” includes both direct connection between components and indirect connection between components via another component.

### First Embodiment

An example of radar apparatuses is a frequency-modulated continuous wave (FMCW) radar. The FMCW radar has an advantage of being simple in structure and an advantage of being easy to handle because the frequency band of a beat signal of transmitted and received signals subjected to baseband processing has relatively low frequencies, and has been widely used as an automobile sensor for automobile collision avoidance. The FMCW radar is expected to be used as one of automobile sensors for automatic driving in the future. In the FMCW radar, a transmission signal radiated into space is a signal including an up chirp in which the transmission frequency is changed from a low frequency to a high frequency, and a down chirp in which the transmission frequency is changed from a high frequency to a low frequency. The FMCW radar calculates the range (or distance), the relative velocity, the azimuth angle, etc. to an object, based on information of the sum of and the difference between the peak frequencies of the beat signal obtained from the up chirp and the down chirp individually.

Another example of radar apparatuses is a fast chirp modulation (FCM) radar. In the FCM radar, a transmission signal radiated into space is a signal including either an up chirp in which the modulation frequency is rapidly modulated from a low frequency to a high frequency, or a down chirp in which the modulation frequency is rapidly modulated from a high frequency to a low frequency. The FCM radar calculates the range (or distance), the relative velocity, the azimuth angle, etc. to an object, based on information of the frequency and reception phase of a reception beat signal using either the up chirp or the down chirp.

The FMCW radar requires the paring of the up chirp and the down chirp, whereas the FCM radar does not require the paring. Consequently, the FCM radar has a small load on signal processing and can detect objects with high accuracy, and thus has been widely used as an automobile sensor. In the following description in this document, the FMCW radar and the FCM radar are simply expressed as “radars” or “radar apparatuses” when the FMCW radar and the FCM radar are not distinguished from each other.

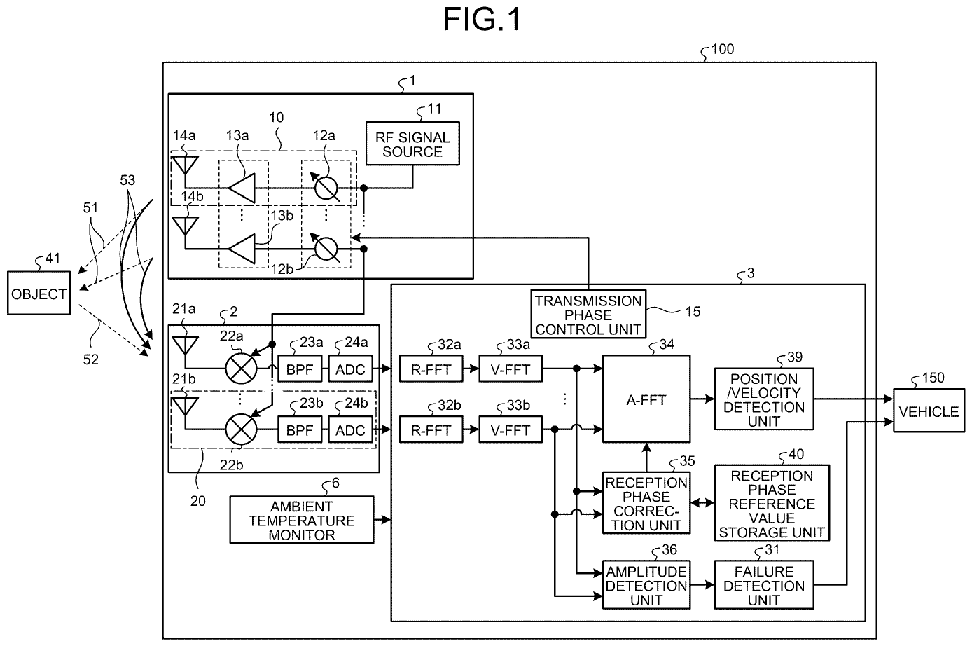

FIG. 1 is a block diagram illustrating an exemplary configuration of a radar apparatus 100 according to a first embodiment. As illustrated in FIG. 1, the radar apparatus 100 according to the first embodiment includes a transmitting circuit 1, a receiving circuit 2, a signal processing unit 3, and an ambient temperature monitor 6.

The transmitting circuit 1 includes a radio frequency (RF) signal source 11, phase shifters 12a and 12b, amplifiers 13a and 13b, and transmitting antennas 14a and 14b. The transmitting circuit 1 transmits a signal generated by the RF signal source 11 to the transmitting antennas 14a and 14b via the phase shifters 12a and 12b and the amplifiers 13a and 13b. The phase shifters 12a and 12b adjust the phase of the input signal. The amplifiers 13a and 13b individually amplify the signals output from the phase shifters 12a and 12b, respectively. The transmitting antennas 14a and 14b radiate the signals output from the amplifiers 13a and 13b into space as transmission chirp signals 51. The signal generated by the RF signal source 11 is a signal on which the transmission chirp signals 51 are based, and is referred to as a “reference signal” in this document.

In the transmitting circuit 1, a set composed of one of the phase shifters 12, one of the amplifiers 13, and one of the transmitting antennas 14 constitutes a transmitting channel 10. In the first embodiment, the minimum number of the transmitting channels 10 is two. That is, the radar apparatus 100 according to the first embodiment includes a plurality of the transmitting channels 10 that generate transmission chirp signals.

The receiving circuit 2 includes receiving antennas 21a and 21b, mixers 22a and 22b, band pass filters (BPFs) 23a and 23b, and analog to digital converters (ADCs) 24a and 24b. The receiving circuit 2 receives, with the receiving antennas 21a and 21b, reflected waves 52 of the transmission chirp signals 51 radiated into space and reflected at an object 41. The mixers 22a and 22b mix the received signals using the reference signal output from the RF signal source 11. The BPFs 23a and 23b perform band-pass filtering on beat signals mixed by the mixers 22a and 22b. The ADCs 24a and 24b perform A/D conversion processing and transmit the converted signals to the signal processing unit 3. As illustrated in FIG. 1, direct waves 53 to be directly coupled are present from the transmitting circuit 1 to the receiving circuit 2. The receiving circuit 2 also receives the direct waves 53 and performs processing described below.

In the receiving circuit 2, a set composed of one of the receiving antennas 21, one of the mixers 22, one of the BPFs 23, and one of the ADCs 24 constitutes a receiving channel 20. In the first embodiment, the minimum number of the receiving channels 20 is two. That is, the radar apparatus 100 according to the first embodiment includes a plurality of the receiving channels 20 that receive the reflected waves 52 of the transmission chirp signals radiated from the transmitting channels 10 and reflected at the object 41, and the direct waves 53 not via the object 41, and mix the received signals using the reference signal on which the transmission chirp signals are based.

The signal processing unit 3 performs detection processing to detect information on the object 41, based on the beat signals mixed by the receiving channels 20. To implement this function, the signal processing unit 3 includes range-fast Fourier transform (R-FFT) units 32a and 32b, velocity-fast Fourier transform (V-FFT) units 33a and 33b, an azimuth-fast Fourier transform (A-FFT) unit 34, a position/velocity detection unit 39, a transmission phase control unit 15, an amplitude detection unit 36, a failure detection unit 31, a reception phase correction unit 35, and a reception phase reference value storage unit 40.

The R-FFT units 32a and 32b are processing units that perform fast Fourier transforms in the range direction (or distance direction). The V-FFT units 33a and 33b are processing units that perform fast Fourier transforms in the velocity direction. The A-FFT unit 34 is a processing unit that performs a fast Fourier transform in the azimuth angle direction, that is, the horizontal angle direction.

The position/velocity detection unit 39 detects the position, velocity, and azimuth angle of the object 41, based on the results of calculation by the R-FFT units 32a and 32b, the V-FFT units 33a and 33b, and the A-FFT unit 34, and transmits the detection results to a vehicle 150. The R-FFT units 32a and 32b, the V-FFT units 33a and 33b, and the position/velocity detection unit 39 are processing units to detect the position and velocity of the object 41 based on the beat signals. These processing units are sometimes collectively referred to as a “first processing unit” in this document. The A-FFT unit 34 and the position/velocity detection unit 39 are processing units to detect the azimuth angle of the object 41, based on the beat signals and the results of processing by the first processing unit. These processing units are sometimes collectively referred to as a “second processing unit” in this document.

The radar apparatus 100 according to the first embodiment includes, in addition to an object detection mode for detecting object information, a failure detection mode for detecting failure of the radar apparatus 100 and a performance correction mode for correcting the performance of the radar apparatus 100. Performance correction modes include a reception phase correction mode, a transmission amplitude correction mode, a transmission phase correction mode, and the like. These various correction modes are performed to prevent the performance degradation of the radar apparatus 100. Suppose that the radar apparatus 100 according to the first embodiment includes at least the reception phase correction mode in addition to the object detection mode and the failure detection mode.

The transmission phase control unit 15 controls the amounts of phase shift of the phase shifters 12a and 12b individually in the failure detection mode and the reception phase correction mode. Specifically, the transmission phase control unit 15 modulates the transmission phases of the transmission chirp signals with different degrees of modulation for the individual transmitting channels 10. That is, the transmission phase control unit 15 applies independent transmission phase modulation to each transmitting channel 10. This processing uses the characteristics that by independently applying transmission phase modulation to the transmission chirp signal of each transmitting channel 10, spectral peaks of a reception beat signal due to the direct waves 53 occur in different range bins or velocity bins. A range bin is a minimum unit width for identifying a difference in the range to an object. A velocity bin is a minimum unit width for identifying a difference in the relative velocity to an object. In a typical radar apparatus, the widths of range bins and velocity bins are determined by range and velocity resolutions. In a typical radar apparatus, range bins and velocity bins are numbered, and the range bins and the velocity bins are identified by the numbers.

The amplitude detection unit 36 detects the amplitudes of the direct waves 53, based on spectral amplitude intensities obtained by the R-FFT units 32a and 32b and the V-FFT units 33a and 33b. The failure detection unit 31 determines the presence or absence of failure of the radar apparatus 100, based on amplitude information obtained by the amplitude detection unit 36, and transmits the determination result to the vehicle 150.

The reception phase reference value storage unit 40 is a storage unit that holds reception phase reference values that are reception phase information. The reception phase reference values are reception phases obtained from spectra due to the direct waves 53 in R-FFT and V-FFT processing, and are calculated in all the receiving channels 20. Processing to calculate the reception phase reference values is performed under an environment in which there are no reflected wave components from the object 41 at the time of shipping inspection, for example.

The reception phase correction unit 35 calculates the amounts of change in reception phases, based on the reception phases in the spectra obtained by the R-FFT units 32a and 32b and the V-FFT units 33a and 33b, and the reception phase reference values stored in the reception phase reference value storage unit 40, and reflects the calculated amounts of change onto processing by the A-FFT unit 34.

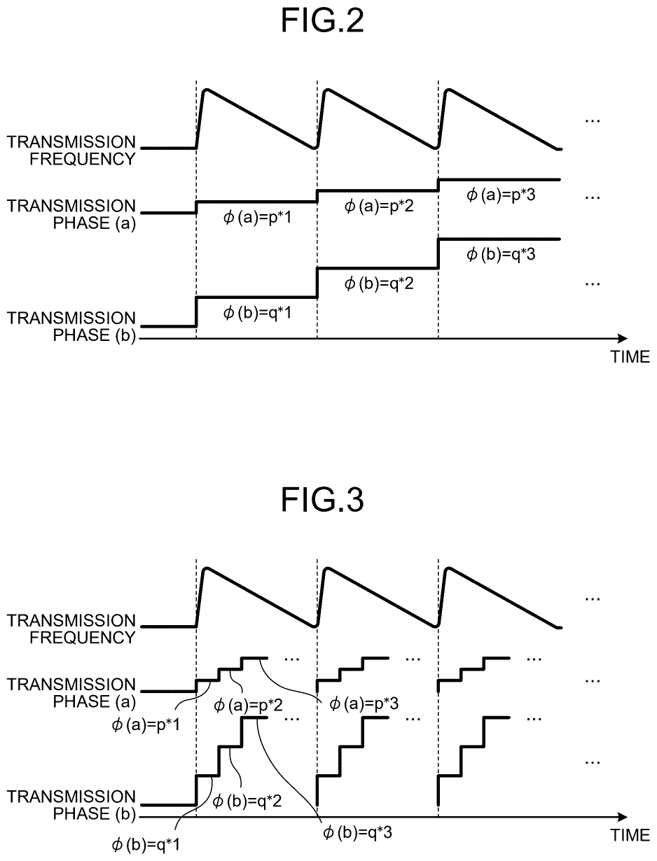

FIG. 2 is a diagram illustrating a first example of time waveforms of a transmission frequency and transmission phases in the failure detection mode in the first embodiment. FIG. 3 is a diagram illustrating a second example of time waveforms of the transmission frequency and the transmission phases in the failure detection mode in the first embodiment. As illustrated in each upper part, the transmission frequency repeats a time-varying chirp waveform. A “transmission phase (a)” illustrated in each middle part represents transmission phase shifts (i.e. transmission phase change) applied to the components with the subscript “a” in FIG. 1, that is, the transmitting channel 10 with the subscript “a”. A “transmission phase (b)” represents transmission phase shifts (i.e. transmission phase change) applied to the components with the subscript “b” in FIG. 1, that is, the transmitting channel 10 with the subscript “b”. In the following description, for the sake of convenience, the transmitting channel 10 with the subscript “a” is sometimes referred to as a “transmitting channel a”, and the transmitting channel 10 with the subscript “b” as a “transmitting channel b”. The same applies to the receiving channels 20. The transmitting channels 10 and the receiving channels 20 are sometimes simply referred to as “channels a” and “channels b” when the transmitting channels 10 and the receiving channels 20 are not particularly distinguished from each other.

The transmission phase control unit 15 shifts the transmission phases by setting different shift widths (i.e. different change widths) of transmission phase shift independently for the individual transmitting channels 10 and providing the set values to the phase shifters 12a and 12b in the failure detection mode during shipping inspection and operation. Specifically, FIG. 2 illustrates an example in which the transmission phases of the transmitting channels a and b are increased stepwise at chirp periods, and FIG. 3 illustrates an example in which the transmission phases of the transmitting channels a and b are increased stepwise within chirp periods, where p is the shift width (i.e. the change width) for the transmitting channel a, and q is the shift width (i.e. the change width) for the transmitting channel b. Note that the examples in FIGS. 2 and 3 are examples. The transmission phases may be provided in any way as long as different transmission phases are independently provided to the individual transmitting channels a and b.

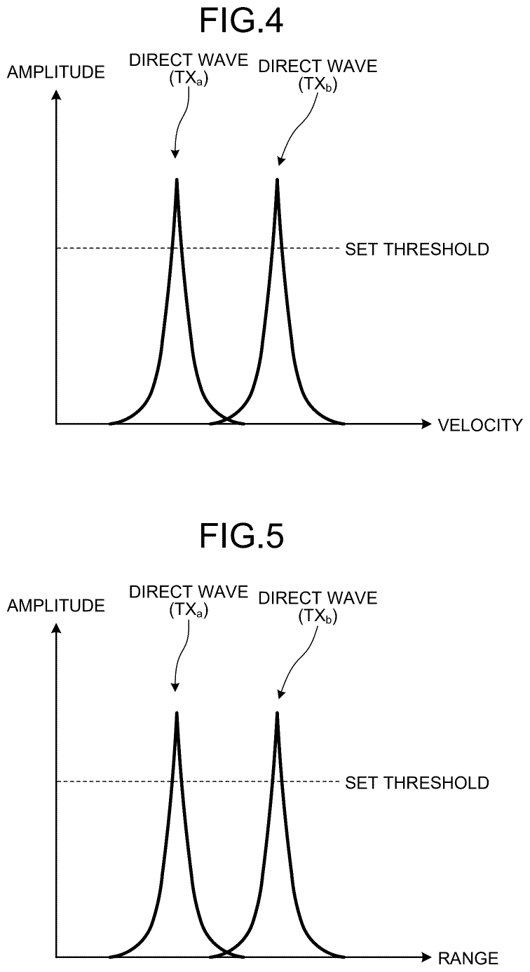

FIG. 4 is a diagram illustrating spectral results of received data in any one of the receiving channels 20 corresponding to the waveforms illustrated in FIG. 2. FIG. 5 is a diagram illustrating spectral results of received data in any one of the receiving channels 20 corresponding to the waveforms illustrated in FIG. 3. The received data in any one of the receiving channels 20 referred to here is data that has been subjected to R-FFT processing and V-FFT processing and output from either the V-FFT unit 33a or the V-FFT unit 33b in the configuration of FIG. 1. The horizontal axis in FIG. 4 represents velocity, the horizontal axis in FIG. 5 represents range (or distance), and the vertical axes in FIGS. 4 and 5 represent amplitude.

When the transmission phase control unit 15 performs transmission phase modulation with the waveforms illustrated in FIG. 2, as illustrated in FIG. 4, direct wave components TXₐ and TX_{b} from the two transmitting channels a and b show amplitude peaks at positions corresponding to the respective degrees of modulation in the velocity axis direction. The same applies to the example of FIG. 5. Therefore, even when transmission signals are simultaneously transmitted from the two transmitting channels a and b, the two signals can be separated in the velocity-frequency domain. Even in a case where there are three or more transmitting channels 10, transmission phase modulation with different degrees of modulation are performed, so that even when transmission signals are simultaneously transmitted from the three or more transmitting channels 10, their respective direct wave components can be separately extracted in the velocity-frequency domain.

In the first embodiment, the amplitude detection unit 36 detects the amplitudes of the direct wave components from the respective transmitting channels 10, and compares the amplitudes with a set threshold to determine the presence or absence of failure of the radar apparatus 100.

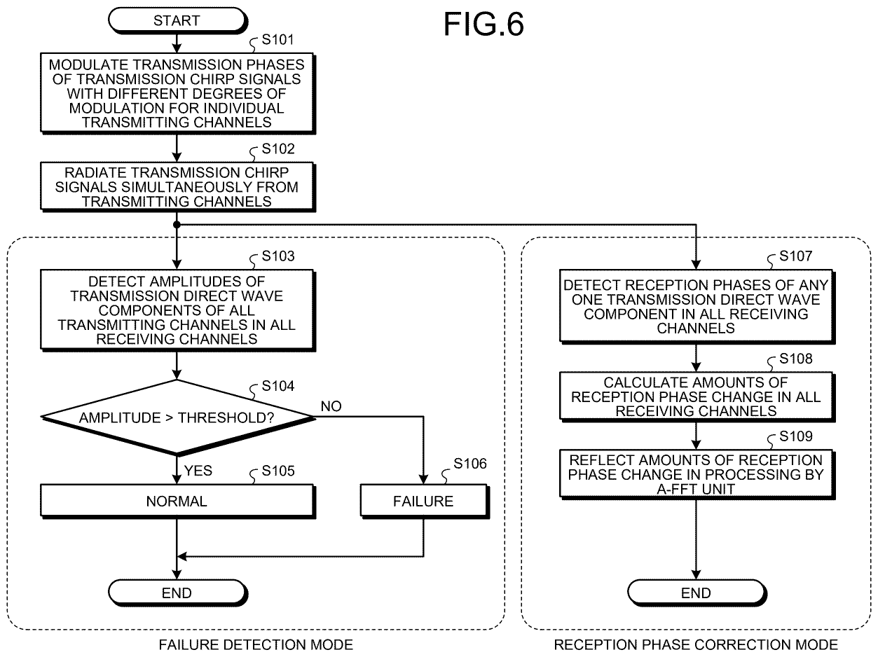

FIG. 6 is a flowchart for explaining operations in the failure detection mode by the failure detection unit 31 and the reception phase correction mode by the reception phase correction unit 35 in the first embodiment. The failure detection mode and the reception phase correction mode illustrated in FIG. 6 can be activated even during the operation of the radar apparatus 100. That is, the operation flow of the failure detection mode and the reception phase correction mode illustrated in FIG. 6 can be performed even when the radar apparatus 100 is in transmission and reception operations.

The radar apparatus 100 modulates the transmission phases of the transmission chirp signals 51 with different degrees of modulation for the individual transmitting channels 10 (step S101), and radiates the transmission chirp signals 51 simultaneously from the plurality of transmitting channels 10 (step S102). Steps S101 and S102 are common to the failure detection mode and the reception phase correction mode.

Next, the operation in the failure detection mode will be described. The operation in the failure detection mode is illustrated on the left side of FIG. 6. First, part of the transmission chirp signals 51 are received as the direct waves 53 by the receiving circuit 2. Received data output from the receiving circuit 2 is transmitted to the signal processing unit 3.

The signal processing unit 3 detects, in all the receiving channels 20, the amplitudes of all the transmission direct wave components, that is, the amplitudes of the direct wave components radiated from all the transmitting channels 10 (step S103). When the amplitudes of the direct wave components are greater than the threshold (step S104, Yes), the failure detection unit 31 determines that the radar apparatus 100 is normal (step S105) and ends the failure detection mode. In contrast, when the amplitudes of the direct wave components are less than or equal to the threshold (step S104, No), the failure detection unit 31 determines that a failure occurs in the radar apparatus 100 (step S106) and ends the failure detection mode.

Next, the operation in the reception phase correction mode will be described. The operation in the reception phase correction mode is illustrated on the right side of FIG. 6.

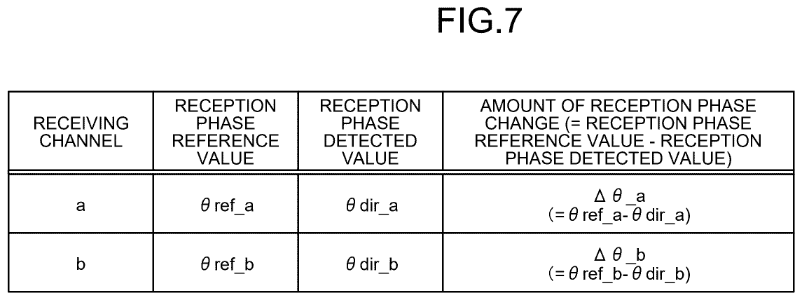

The signal processing unit 3 detects, in all the receiving channels 20, the reception phases of the transmission direct wave component radiated from any one of the transmitting channels 10 (step S107). Then, the signal processing unit 3 calculates the amounts of reception phase change in all the receiving channels 20 (step S108). A method of calculating the amounts of reception phase change will be described further with reference to FIG. 7. FIG. 7 is a diagram for explaining the method of calculating the amounts of reception phase change in the reception phase correction mode in the first embodiment. In the description of FIG. 7, the number of the receiving channels 20 is two, namely the receiving channels a and b, according to the configuration illustrated in FIG. 1. As described above, the reception phase reference values have been stored in the reception phase reference value storage unit 40.

First, as illustrated in FIG. 7, “θref_a” and “θref_b” are the reception phase reference values of the receiving channels a and b stored in the reception phase reference value storage unit 40, respectively. “θdir_a” and “θdir_b” are reception phase detected values of the receiving channels a and b due to the direct wave component radiated from any one of the transmitting channels 10 detected in step S107. Each reception phase detected value can be obtained using data of a spectral peak bin due to the direct wave 53. The peak bin is a velocity bin or a range bin in which a spectral peak due to the direct wave 53 appears. “Δθ_a” and “Δθ_b” are the amounts of reception phase change in the receiving channels a and b, respectively. As illustrated in FIG. 7, the amounts of reception phase change Δθ_a and Δθ_b can be calculated by the calculation formulas “Δθ_a=θref_a−θdir_a” and “Δθ_b=θref_b'θdir_b”, respectively. That is, the amounts of reception phase change can be obtained by calculating the differences between the reception phase reference values and the reception phase detected values.

Returning to the operation flow in FIG. 6, the reception phase correction unit 35 reflects the amounts of reception phase change calculated in step S108 onto the processing by the A-FFT unit 34 (step S109), and ends the reception phase correction mode.

The threshold in the failure detection mode illustrated in the flowchart of FIG. 6 is determined using measured values of the direct wave components under an environment where there are no reflected wave components from the object 41 at the time of shipping inspection, for example. At this time, the direct wave components may be measured at varying ambient temperatures, and a temperature table for the threshold may be created for each transmitting channel 10. Ambient temperatures in the temperature table may be set and referred to by corresponding the temperature detected value of the ambient temperature monitor 6 to the actual ambient temperature.

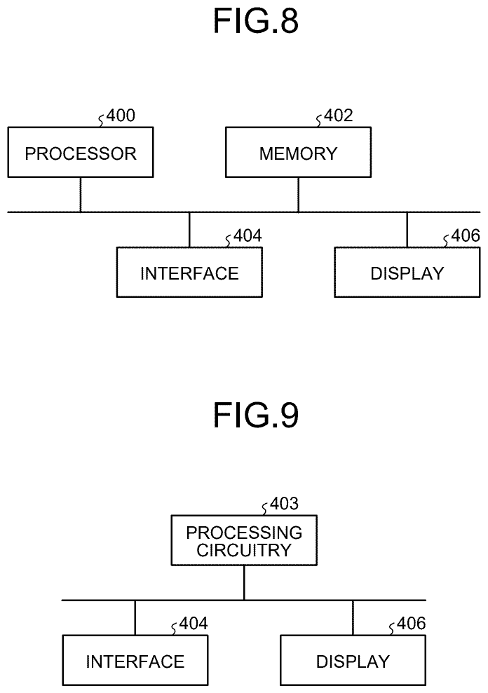

Next, a hardware configuration for implementing the functions of the signal processing unit 3 in the first embodiment will be described with reference to the drawings in FIGS. 8 and 9. FIG. 8 is a block diagram illustrating an example of the hardware configuration that implements the functions of the signal processing unit 3 in the first embodiment. FIG. 9 is a block diagram illustrating another example of the hardware configuration that implements the functions of the signal processing unit 3 in the first embodiment.

When the functions of the signal processing unit 3 in the first embodiment are implemented by software, as illustrated in FIG. 8, the configuration may include a processor 400 that performs calculations, a memory 402 that is a storage unit in which a program read by the processor 400 is stored, an interface 404 that inputs and outputs signals, and a display 406 that displays detection results.

The processor 400 may be an arithmetic means called an arithmetic device, a microprocessor, a microcomputer, a central processing unit (CPU), or a digital signal processor (DSP). The memory 402 can be exemplified by nonvolatile or volatile semiconductor memory such as random-access memory (RAM), read-only memory (ROM), flash memory, an erasable programmable ROM (EPROM), or an electrically EPROM (EEPROM) (registered trademark), or a magnetic disk, a flexible disk, an optical disk, a compact disc, a mini disc, or a digital versatile disc (DVD).

The memory 402 stores not only a program to implement the functions of the signal processing unit 3 but also the threshold, temperature table values, the reception phase reference values, etc. The processor 400 exchanges necessary information via the interface 404. The processor 400 executes the program stored in the memory 402. The processor 400 can perform pieces of processing in the object detection mode, the failure detection mode, and the performance correction mode described above by referring to the threshold, the temperature table values, and the reception phase reference values stored in the memory 402. The results of calculations by the processor 400 can be stored in the memory 402. The results of processing by the processor 400 can also be displayed on the display 406. Note that the display 406 may be provided outside the signal processing unit 3.

The processor 400 and the memory 402 illustrated in FIG. 8 may be replaced with processing circuitry 403 as in FIG. 9. The processing circuitry 403 may correspond to a single circuit, a combined circuit, an application specific integrated circuit (ASIC), a field-programmable gate array (FPGA), or a combination thereof.

As described above, in the radar apparatus according to the first embodiment, the signal processing unit that performs the object detection processing includes the first and second processing units, the transmission phase control unit, the storage unit, and the reception phase correction unit. The first processing unit performs processing to detect the position and velocity of the object, based on the beat signals. The second processing unit performs processing to detect the azimuth angle of the object, based on the beat signals and the results of the processing by the first processing unit. The transmission phase control unit modulates the transmission phases of the transmission chirp signals with different degrees of modulation for the individual transmitting channels. The storage unit holds the reception phase reference values that are the reception phase information. The reception phase correction unit calculates the amounts of change in the reception phases, based on the reception phases in the spectra obtained by the first processing unit and the reception phase reference values held in the storage unit, and reflects the calculated amounts of change onto the processing by the second processing unit. According to the radar apparatus configured like this, during the operation of the radar apparatus, the transmission chirp signals used for failure determination of the radar apparatus are simultaneously radiated into space from the plurality of transmitting channels. This can prevent an increase in the time required for failure determination of the radar apparatus. Further, the radar apparatus according to the first embodiment allows the processing in the failure detection mode and the processing in the reception phase correction mode performed to prevent the performance degradation of the radar apparatus, to be performed simultaneously in parallel in the same processing flow. Consequently, the processing in the failure detection mode and the reception phase correction mode can be performed in a short time during the operation of the radar apparatus. Since the processing in the plurality of operation modes can be performed in a short time, the power consumption of the radar apparatus can be reduced.

A method of operating a radar apparatus according to the first embodiment is a method of operating a radar apparatus performed using a radar apparatus configured as described above, and can be a process including a modulation step, a radiation step, an amplitude detection step, and a determination step described below. In the modulation step, the transmission phases of the transmission chirp signals are modulated with different degrees of modulation for the individual transmitting channels. In the radiation step, the transmission chirp signals generated in the modulation step are simultaneously radiated from the plurality of transmitting channels into space. In the amplitude detection step, the direct waves of the transmission chirp signals radiated in the radiation step are received, and the amplitudes of the transmission direct wave components of all the transmitting channels are detected in all the receiving channels. In the determination step, failure of the radar apparatus is determined based on the results of comparison between the amplitudes of the transmission direct wave components detected in the amplitude detection step and the preset threshold. The above-described method of operating the radar apparatus including the modulation step, the radiation step, the amplitude detection step, and the determination step can prevent an increase in the time required for failure determination of the radar apparatus.

The method of operating the radar apparatus according to the first embodiment can be a process including a phase detection step, a calculation step, and a reflection step described below in addition to the process of the modulation step, the radiation step, the amplitude detection step, and the determination step described above. In the phase detection step, the direct waves of the transmission chirp signals radiated in the above radiation step are received, and the reception phases of any one of the transmission direct wave components are detected in all the receiving channels. In the calculation step, the amounts of reception phase change are calculated, based on the detected values of the reception phase detected in the phase detection step and the reception phase reference values held in advance. In the reflection step, the amounts of reception phase change calculated in the calculation step are reflected onto the object detection processing. According to this method of operating the radar apparatus further including the phase detection step, the calculation step, and the reflection step, radar apparatus failure detection processing and reception phase correction processing performed to prevent the performance degradation of the radar apparatus can be performed simultaneously in parallel in the same processing flow. Consequently, these pieces of processing can be performed in a short time during the operation of the radar apparatus. Furthermore, since the processing in the plurality of operation modes can be performed in a short time, the power consumption of the radar apparatus can be reduced.

### Second Embodiment

In a radar apparatus, the amplitude characteristics of transmission signals are known to vary greatly due to manufacturing variations in semiconductor devices on an integrated circuit constituting transmitting channels, fluctuations in power supply voltage, changes in ambient temperature, etc. When the amplitude characteristics of the transmission signals vary, amplitude differences occur between signal paths of a plurality of transmitting channels, resulting in a decrease in the detection accuracy of the range (or distance), the relative velocity, the azimuth angle, etc. of an object. A second embodiment thus proposes a configuration and a method for reducing the effects of amplitude differences that can occur between signal paths of a plurality of transmitting channels.

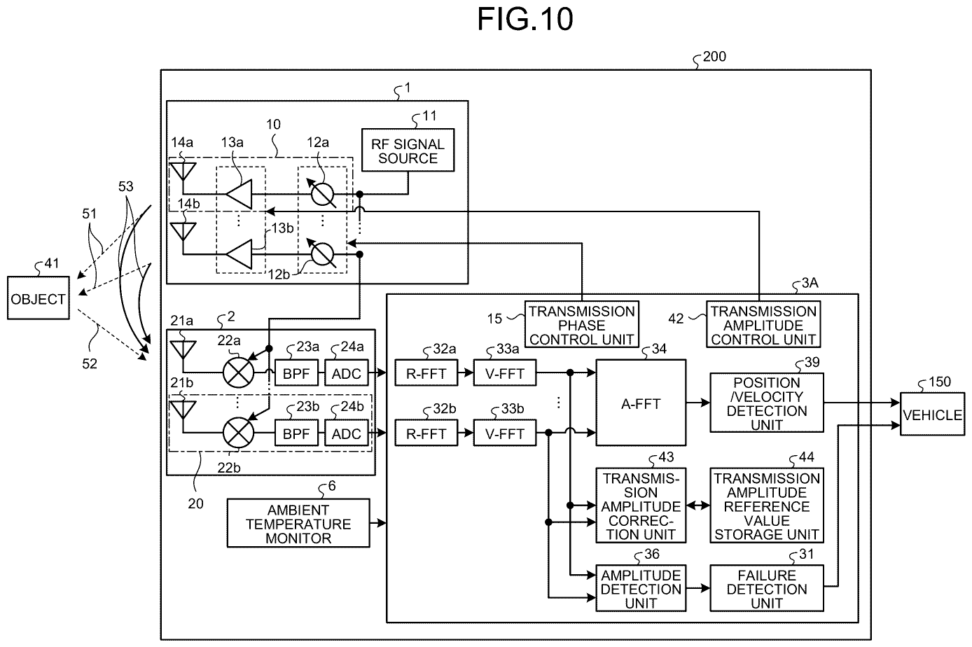

FIG. 10 is a block diagram illustrating a configuration of a radar apparatus 200 according to the second embodiment. Of the components illustrated in FIG. 10, components that achieve the same functions as those of the radar apparatus 100 of the first embodiment illustrated in FIG. 1 are denoted by the same reference numerals, and duplicated descriptions thereof will be omitted as appropriate.

In FIG. 10, in the radar apparatus 200 according to the second embodiment, the signal processing unit 3 illustrated in FIG. 1 is replaced with a signal processing unit 3A. Further, in the signal processing unit 3A illustrated in FIG. 10, the reception phase correction unit 35 in the signal processing unit 3 illustrated in FIG. 1 is replaced with a transmission amplitude correction unit 43, and the reception phase reference value storage unit 40 in the signal processing unit 3 illustrated in FIG. 1 is replaced with a transmission amplitude reference value storage unit 44. Furthermore, in the signal processing unit 3A illustrated in FIG. 10, a transmission amplitude control unit 42 is added.

The transmission amplitude reference value storage unit 44 is a storage unit that holds transmission amplitude reference values that are amplitude information of the transmission signals. The transmission amplitude reference values are amplitude information of the transmission signals obtained from a spectrum due to the direct waves 53 in R-FFT and V-FFT processing, and are calculated in at least one of the receiving channels 20. Processing to calculate the transmission amplitude reference values is performed under an environment where there are no reflected wave components from the object 41 at the time of shipping inspection, for example.

The transmission amplitude correction unit 43 calculates the amounts of change in transmission amplitudes, based on transmission amplitudes that are spectral amplitude information obtained by the R-FFT units 32a and 32b and the V-FFT units 33a and 33b, and the transmission amplitude reference values stored in the transmission amplitude reference value storage unit 44, and reflects the calculated amounts of change onto processing by the transmission amplitude control unit 42.

The transmission amplitude control unit 42 controls the amplification factors of the amplifiers 13a and 13b according to the amounts of change in the transmission amplitudes calculated by the transmission amplitude correction unit 43, to change the amplitudes of the transmission chirp signals during operation.

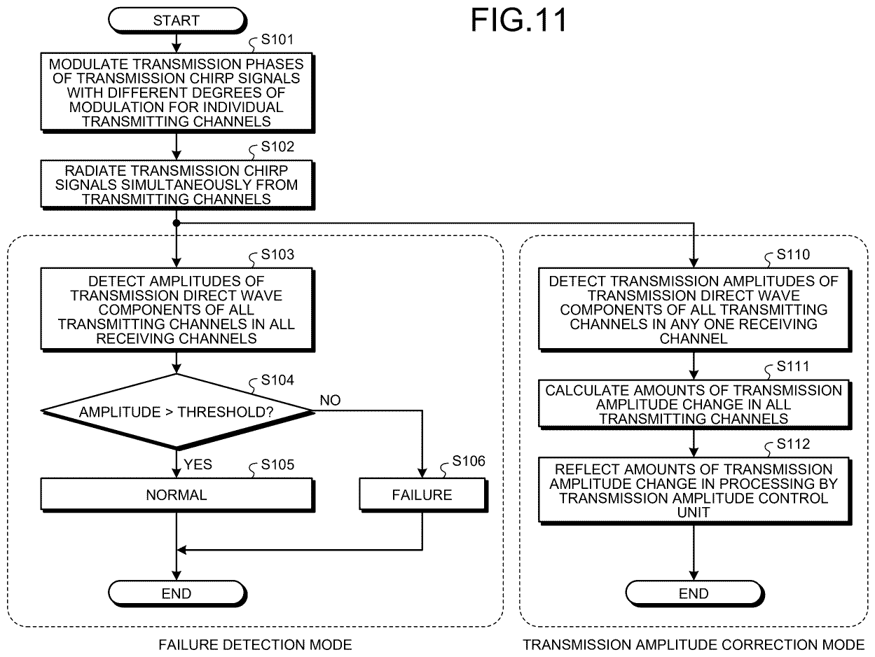

Next, the operation of the radar apparatus 200 according to the second embodiment will be described with reference to the drawings in FIGS. 10 and 11. FIG. 11 is a flowchart for explaining operations in the failure detection mode by the failure detection unit 31 and a transmission amplitude correction mode by the transmission amplitude correction unit 43 according to the second embodiment. The failure detection mode and the transmission amplitude correction mode illustrated in FIG. 11 can be activated even during the operation of the radar apparatus 200. That is, the operation flow of the failure detection mode and the transmission amplitude correction mode illustrated in FIG. 11 can be performed even when the radar apparatus 200 is in transmission and reception operations.

The radar apparatus 200 modulates the transmission phases of the transmission chirp signals 51 with different degrees of modulation for the individual transmitting channels 10 (step S101), and simultaneously radiates the transmission chirp signals 51 from the plurality of transmitting channels 10 (step S102). Steps S101 and S102 are common to the failure detection mode and the transmission amplitude correction mode. The operation flow of the failure detection mode is illustrated on the left side of FIG. 11. Processing in steps S103 to S106 is the same as that on the left side of FIG. 6, and the description thereof is omitted here.

Next, the operation in the transmission amplitude correction mode will be described. The operation in the transmission amplitude correction mode is illustrated on the right side of FIG. 11.

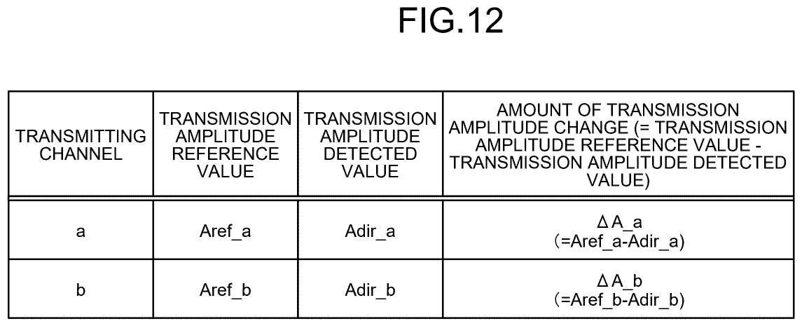

The signal processing unit 3A detects the transmission amplitudes of the transmission direct wave components radiated from all the transmitting channels 10 in any one of the receiving channels 20 (step S110). Then, the signal processing unit 3A calculates the amounts of transmission amplitude change in all the transmitting channels 10 (step S111). A method of calculating the amounts of transmission amplitude change will be described further with reference to FIG. 12. FIG. 12 is a diagram for explaining the method of calculating the amounts of transmission amplitude change in the transmission amplitude correction mode in the second embodiment. In the description of FIG. 12, the number of the transmitting channels 10 is two, namely the transmitting channels a and b, according to the configuration illustrated in FIG. 1.

As described above, the transmission amplitude reference values have been stored in the transmission amplitude reference value storage unit 44.

First, as illustrated in FIG. 12, “Aref_a” and “Aref_b” are the transmission amplitude reference values of the transmitting channels a and b stored in the transmission amplitude reference value storage unit 44, respectively. “Adir_a” and “Adir_b” are transmission amplitude detected values that are detected values in the receiving channel a or the receiving channel b, which is any one of the receiving channels 20, due to the direct wave components radiated from all the transmitting channels a and b, detected in step S110. The transmission amplitude detected values can be obtained using data of spectral peak bins due to the direct waves 53. The peak bins are velocity bins or range bins in which spectral peaks due to the direct waves 53 appear. “ΔA_a” and “ΔA_b” are the amounts of transmission amplitude change in the transmitting channels a and b, respectively. As illustrated in FIG. 12, the amounts of transmission amplitude change ΔA_a and ΔA_b can be calculated by the calculation formulas “ΔA_a=Aref_a−Adir_a” and “ΔA_b=Aref_b−Adir_b”, respectively. That is, the amounts of transmission amplitude change can be obtained by calculating the differences between the transmission amplitude reference values and the transmission amplitude detected values.

Returning to the operation flow in FIG. 11, the transmission amplitude correction unit 43 reflects the amounts of transmission amplitude change calculated in step S111 onto the processing by the transmission amplitude control unit 42 (step S112), and ends the transmission amplitude correction mode.

As described above, in the radar apparatus according to the second embodiment, the signal processing unit that performs the object detection processing includes the first and second processing units, the transmission phase control unit, the storage unit, the transmission amplitude correction unit, and the transmission amplitude control unit. The first processing unit performs processing to detect the position and velocity of the object, based on the beat signals. The second processing unit performs processing to detect the azimuth angle of the object, based on the beat signals and the results of the processing by the first processing unit. The transmission phase control unit modulates the transmission phases of the transmission chirp signals with different degrees of modulation for the individual transmitting channels. The storage unit holds the transmission amplitude reference values that are the amplitude information of the transmission signals. The transmission amplitude correction unit calculates the amounts of change in the transmission amplitudes, based on the reception phases in the spectrum obtained by the first processing unit and the transmission amplitude reference values held in the storage unit. The transmission amplitude control unit performs control to change the amplitudes of the transmission chirp signals, based on the amounts of change in the transmission amplitudes calculated by the transmission amplitude correction unit. According to the radar apparatus configured like this, during the operation of the radar apparatus, the transmission chirp signals used for failure determination of the radar apparatus are simultaneously radiated into space from the plurality of transmitting channels. This can prevent an increase in the time required for failure determination of the radar apparatus. Further, the radar apparatus according to the second embodiment allows the processing in the failure detection mode and the processing in the transmission amplitude correction mode performed to prevent the performance degradation of the radar apparatus, to be performed simultaneously in parallel in the same processing flow. Consequently, the processing in the failure detection mode and the transmission amplitude correction mode can be performed in a short time during the operation of the radar apparatus. Since the processing in the plurality of operation modes can be performed in a short time, the power consumption of the radar apparatus can be reduced.

A method of operating a radar apparatus according to the second embodiment is a method of operating a radar apparatus performed using a radar apparatus configured as described above, and can be a process including an amplitude detection step, a calculation step, and an amplitude control step described below in addition to the process of the modulation step, the radiation step, the amplitude detection step, and the determination step described in the first embodiment. In the amplitude detection step, the direct waves of the transmission chirp signals radiated in the radiation step are received, and the transmission amplitudes of the transmission direct wave components of all the transmitting channels are detected in any one of the receiving channels. In the calculation step, the amounts of transmission amplitude change are calculated, based on the detected values of the transmission amplitudes detected in the amplitude detection step and the transmission amplitude reference values held in advance. In the amplitude control step, the amounts of transmission amplitude change calculated in the calculation step are reflected onto the amplitude control of the transmission chirp signals to be radiated in the radiation step. According to this method of operating the radar apparatus further including the amplitude detection step, the calculation step, and the amplitude control step, radar apparatus failure detection processing and transmission amplitude correction processing performed to prevent the performance degradation of the radar apparatus can be performed simultaneously in parallel in the same processing flow. Consequently, these pieces of processing can be performed in a short time during the operation of the radar apparatus. Furthermore, since the processing in the plurality of operation modes can be performed in a short time, the power consumption of the radar apparatus can be reduced.

### Third Embodiment

In a radar apparatus, the phase characteristics of transmission signals are known to vary greatly due to manufacturing variations in semiconductor devices on an integrated circuit constituting transmitting channels, fluctuations in power supply voltage, changes in ambient temperature, etc. When the phase characteristics of the transmission signals vary, phase differences occur between signal paths of a plurality of transmitting channels, resulting in a decrease in the detection accuracy of the range, the relative velocity, the azimuth angle, etc. of an object. A third embodiment thus proposes a configuration and a method for reducing the effects of phase differences that can occur between signal paths of a plurality of transmitting channels.

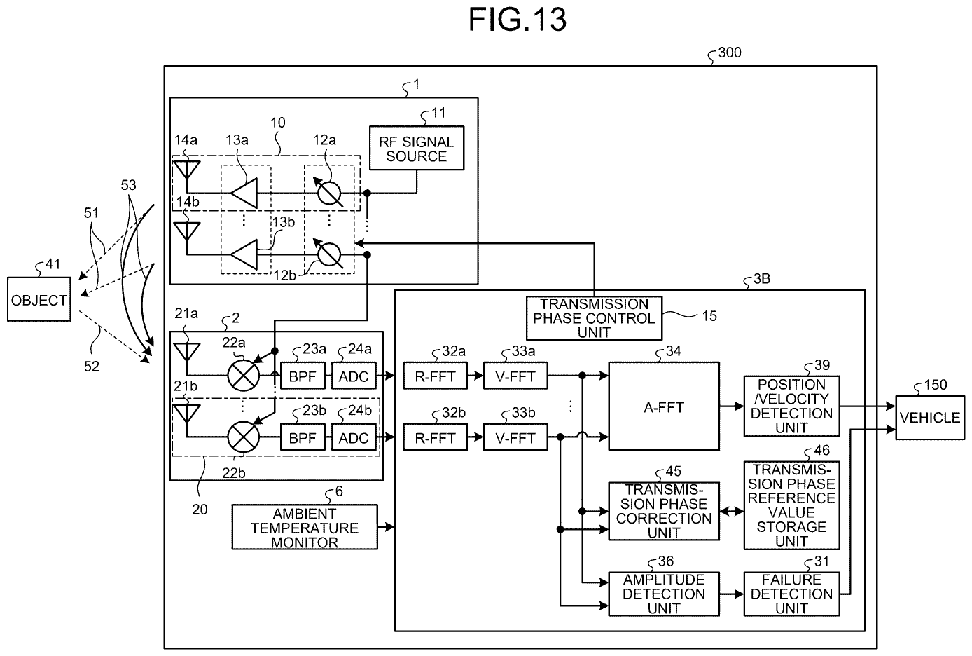

FIG. 13 is a block diagram illustrating a configuration of a radar apparatus 300 according to the third embodiment. Of the components illustrated in FIG. 13, components that achieve the same functions as those of the radar apparatus 100 of the first embodiment illustrated in FIG. 1 are denoted by the same reference numerals, and duplicated descriptions thereof will be omitted as appropriate.

In FIG. 13, in the radar apparatus 300 according to the third embodiment, the signal processing unit 3 illustrated in FIG. 1 is replaced with a signal processing unit 3B. Further, in the signal processing unit 3B illustrated in FIG. 13, the reception phase correction unit 35 in the signal processing unit 3 illustrated in FIG. 1 is replaced with a transmission phase correction unit 45, and the reception phase reference value storage unit 40 in the signal processing unit 3 illustrated in FIG. 1 is replaced with a transmission phase reference value storage unit 46.

The transmission phase reference value storage unit 46 is a storage unit that holds transmission phase reference values that are transmission phase information. The transmission phase reference values are phase information of the transmission signals obtained from a spectrum due to the direct waves 53 in R-FFT and V-FFT processing, and are calculated in at least one of the receiving channels 20. Processing to calculate the transmission phase reference values is performed under an environment in which there are no reflected wave components from the object 41 at the time of shipping inspection, for example.

The transmission phase correction unit 45 calculates the amounts of change in transmission phases, based on transmission phases that are spectral phase information obtained by the R-FFT units 32a and 32b and the V-FFT units 33a and 33b and the transmission phase reference values stored in the transmission phase reference value storage unit 46, and reflects the calculated amounts of change onto processing by the transmission phase control unit 15.

The transmission phase control unit 15 controls the phases of the phase shifters 12a and 12b according to the amounts of change in the transmission phases calculated by the transmission phase correction unit 45, to change the phases of the transmission chirp signals during operation.

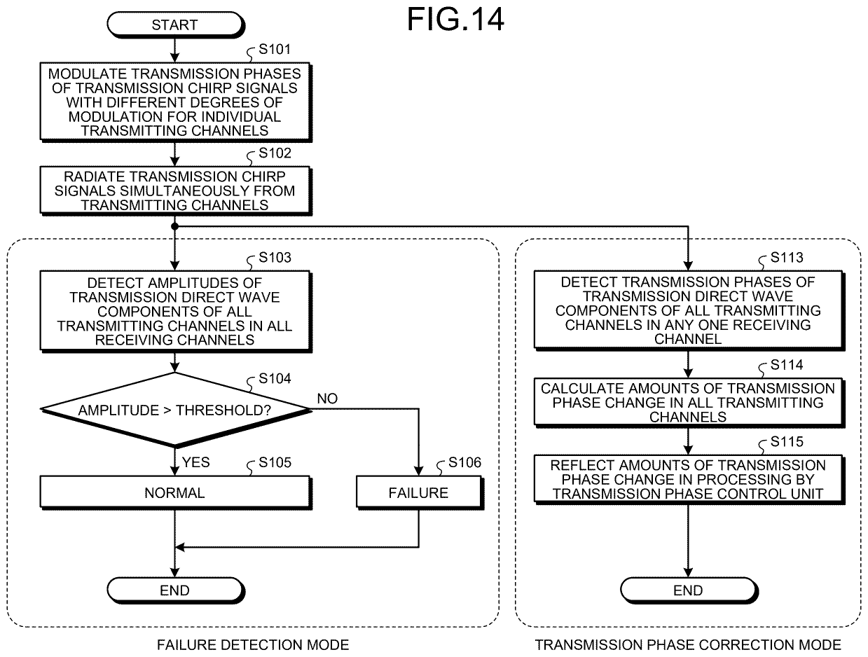

Next, the operation of the radar apparatus 300 according to the third embodiment will be described with reference to the drawings in FIGS. 13 and 14. FIG. 14 is a flowchart for explaining operations in the failure detection mode by the failure detection unit 31 and a transmission phase correction mode by the transmission phase correction unit 45 in the third embodiment. The failure detection mode and the transmission phase correction mode illustrated in FIG. 14 can be activated even during the operation of the radar apparatus 300. That is, the operation flow of the failure detection mode and the transmission phase correction mode illustrated in FIG. 14 can be performed even when the radar apparatus 300 is in transmission and reception operations.

The radar apparatus 300 modulates the transmission phases of the transmission chirp signals 51 with different degrees of modulation for the individual transmitting channels 10 (step S101), and simultaneously radiates the transmission chirp signals 51 from the plurality of transmitting channels 10 (step S102). Steps S101 and S102 are common to the failure detection mode and the transmission phase correction mode. The operation flow of the failure detection mode is illustrated on the left side of FIG. 14. Processing in steps S103 to S106 is the same as that on the left side of FIG. 6, and the description thereof is omitted here.

Next, the operation in the transmission phase correction mode will be described. The operation in the transmission phase correction mode is illustrated on the right side of FIG. 14.

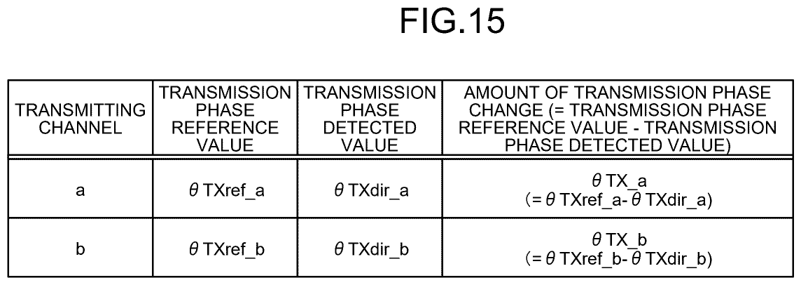

The signal processing unit 3B detects the transmission phases of the transmission direct wave components radiated from all the transmitting channels 10 in any one of the receiving channels 20 (step S113). Then, the signal processing unit 3B calculates the amounts of transmission phase change in all the transmitting channels 10 (step S114). A method of calculating the amounts of transmission phase change will be described further with reference to FIG. 15. FIG. 15 is a diagram for explaining the method of calculating the amounts of transmission phase change in the transmission phase correction mode in the third embodiment. In the description of FIG. 15, the number of the transmitting channels 10 is two, namely the transmitting channels a and b, according to the configuration illustrated in FIG. 1. As described above, the transmission phase reference values have been stored in the transmission phase reference value storage unit 46.

First, as illustrated in FIG. 15, “θTXref_a” and “θTXref_b” are the transmission phase reference values of the transmitting channels a and b stored in the transmission phase reference value storage unit 46, respectively. “θTXdir_a” and “θTXdir_b” are transmission phase detected values that are detected values in the receiving channel a or the receiving channel b, which is any one of the receiving channels 20, due to the direct wave components radiated from all the transmitting channels a and b, detected in step S113. The transmission phase detected values can be obtained using data of spectral peak bins due to the direct waves 53. The peak bins are velocity bins or range bins in which spectral peaks due to the direct waves 53 appear. “θTX_a” and “θTX_b” are the amounts of transmission phase change in the transmitting channels a and b, respectively. As illustrated in FIG. 15, the amounts of transmission phase change θTX_a and θTX_b can be calculated by the calculation formulas “θTX_a=θTXref_a−θTXdir_a” and “θTX_b=θTXref_b−θTXdir_b”, respectively. That is, the amounts of transmission phase change can be obtained by calculating the differences between the transmission phase reference values and the transmission phase detected values.

Returning to the operation flow in FIG. 14, the transmission phase correction unit 45 reflects the amounts of transmission phase change calculated in step S114 onto the processing by the transmission phase control unit 15 (step S115), and ends the transmission phase correction mode.

As described above, in the radar apparatus according to the third embodiment, the signal processing unit that performs the object detection processing includes the first and second processing units, the transmission phase control unit, the storage unit, and the transmission phase correction unit. The first processing unit performs processing to detect the position and velocity of the object, based on the beat signals. The second processing unit performs processing to detect the azimuth angle of the object, based on the beat signals and the results of the processing by the first processing unit. The transmission phase control unit modulates the transmission phases of the transmission chirp signals with different degrees of modulation for the individual transmitting channels. The storage unit holds the transmission phase reference values that are the phase information of the transmission signals. The transmission phase correction unit calculates the amounts of change in the transmission phases, based on the reception phases in the spectrum obtained by the first processing unit and the transmission phase reference values held in the storage unit. The transmission phase control unit performs control to change the phases of the transmission chirp signals, based on the amounts of change in the transmission phases calculated by the transmission phase correction unit. According to the radar apparatus configured like this, during the operation of the radar apparatus, the transmission chirp signals used for failure determination of the radar apparatus are simultaneously radiated into space from the plurality of transmitting channels. This can prevent an increase in the time required for failure determination of the radar apparatus. Further, the radar apparatus according to the third embodiment allows the processing in the failure detection mode and the processing in the transmission phase correction mode performed to prevent the performance degradation of the radar apparatus, to be performed simultaneously in parallel in the same processing flow. Consequently, the processing in the failure detection mode and the transmission phase correction mode can be performed in a short time during the operation of the radar apparatus. Since the processing in the plurality of operation modes can be performed in a short time, the power consumption of the radar apparatus can be reduced.

A method of operating a radar apparatus according to the third embodiment is a method of operating a radar apparatus performed using a radar apparatus configured as described above, and can be a process including a phase detection step, a calculation step, and a phase control step described below in addition to the process of the modulation step, the radiation step, the amplitude detection step, and the determination step described in the first embodiment. In the phase detection step, the direct waves of the transmission chirp signals radiated in the radiation step are received, and the transmission phases of the transmission direct wave components of all the transmitting channels are detected in any one of the receiving channels. In the calculation step, the amounts of transmission phase change are calculated based on the detected values of the transmission phases detected in the phase detection step and the transmission phase reference values held in advance. In the phase control step, the amounts of transmission phase change calculated in the calculation step are reflected onto the phase control of the transmission chirp signals to be radiated in the radiation step. According to this method of operating the radar apparatus further including the phase detection step, the calculation step, and the phase control step, radar apparatus failure detection processing and transmission phase correction processing performed to prevent the performance degradation of the radar apparatus can be performed simultaneously in parallel in the same processing flow. Consequently, these pieces of processing can be performed in a short time during the operation of the radar apparatus. Furthermore, since the processing in the plurality of operation modes can be performed in a short time, the power consumption of the radar apparatus can be reduced.

The configurations described in the above embodiments illustrate an example, and can be combined with another known art. The embodiments can be combined with each other. The configurations can be partly omitted or changed without departing from the gist.

### REFERENCE SIGNS LIST

1 transmitting circuit; 2 receiving circuit; 3, 3A, 3B signal processing unit; 6 ambient temperature monitor; 10 transmitting channel; 11 RF signal source; 12 a, 12b phase shifter; 13a, 13b amplifier; 14a, 14b transmitting antenna; 15 transmission phase control unit; 20 receiving channel; 21a, 21b receiving antenna; 22a, 22b mixer; 31 failure detection unit; 32a, 32b R-FFT unit; 33a, 33b V-FFT unit; 34 A-FFT unit; 35 reception phase correction unit; 36 amplitude detection unit; 39 position/velocity detection unit; 40 reception phase reference value storage unit; 41 object; 42 transmission amplitude control unit; 43 transmission amplitude correction unit; 44 transmission amplitude reference value storage unit; 45 transmission phase correction unit; 46 transmission phase reference value storage unit; 51 transmission chirp signal; 52 reflected wave; 53 direct wave; 100, 200, 300 radar apparatus; 150 vehicle; 400 processor; 402 memory; 403 processing circuitry; 404 interface; 406 display.

1. A radar apparatus comprising: a plurality of transmitting channels to generate transmission chirp signals; a plurality of receiving channels to receive reflected waves of the transmission chirp signals radiated from the transmitting channels and reflected at an object, and mix received signals using a reference signal on which the transmission chirp signals are based; and signal processing circuitry to perform detection processing on the object, based on beat signals mixed by the receiving channels,
the signal processing circuitry including
first processing circuitry to detect a position and a velocity of the object, based on the beat signals,
second processing circuitry to detect an azimuth angle of the object, based on the beat signals and results of processing by the first processing circuitry,
transmission phase control circuitry to modulate transmission phases of the transmission chirp signals with different degrees of modulation for the individual transmitting channels,
a memory to hold reception phase reference values that are reception phase information, and
reception phase correction circuitry to calculate amounts of change in reception phases, based on the reception phases in spectra obtained by the first processing circuitry and the reception phase reference values held in the memory, and reflect the calculated amounts of change onto processing by the second processing circuitry.

2. The radar apparatus according to claim 1, wherein
the radar apparatus includes a performance correction mode to correct performance of the radar apparatus,
in the performance correction mode, the plurality of receiving channels receive direct waves of the transmission chirp signals whose transmission phases have been modulated with the different degrees of modulation for the individual transmitting channels, and
the signal processing circuitry detects reception phases of any one transmission direct wave component in all the receiving channels, calculates amounts of reception phase change in all the receiving channels, and reflects the calculated amounts of reception phase change onto the processing by the second processing circuitry.

3. A radar apparatus comprising: a plurality of transmitting channels to generate transmission chirp signals; a plurality of receiving channels to receive reflected waves of the transmission chirp signals radiated from the transmitting channels and reflected at an object, and mix received signals using a reference signal on which the transmission chirp signals are based; and signal processing circuitry to detect object information, based on beat signals mixed by the receiving channels,
the signal processing circuitry including
first processing circuitry to detect a position and a velocity of the object, based on the beat signals,
second processing circuitry to detect an azimuth angle of the object, based on the beat signals and results of processing by the first processing circuitry,
transmission phase control circuitry to modulate transmission phases of the transmission chirp signals with different degrees of modulation for the individual transmitting channels,
a memory to hold transmission amplitude reference values that are amplification information of transmission signals,
transmission amplitude correction circuitry to calculate amounts of change in transmission amplitudes, based on transmission amplitudes in a spectrum obtained by the first processing circuitry and the transmission amplitude reference values held in the memory, and
transmission amplitude control circuitry to perform control to change amplitudes of the transmission chirp signals, based on the amounts of change in the transmission amplitudes calculated by the transmission amplitude correction circuitry.

4. The radar apparatus according to claim 3, wherein
the radar apparatus includes a performance correction mode to correct performance of the radar apparatus,
in the performance correction mode, the plurality of receiving channels receive direct waves of the transmission chirp signals whose transmission phases have been modulated with the different degrees of modulation for the individual transmitting channels, and
the signal processing circuitry detects amplitudes of transmission direct wave components of all the transmitting channels in any one of the receiving channels, calculates amounts of transmission amplitude change in all the transmitting channels, and reflects the calculated amounts of transmission amplitude change onto processing by the transmission amplitude control circuitry.

5. A radar apparatus comprising: a plurality of transmitting channels to generate transmission chirp signals; a plurality of receiving channels to receive reflected waves of the transmission chirp signals radiated from the transmitting channels and reflected at an object, and mix received signals using a reference signal on which the transmission chirp signals are based; and signal processing circuitry to detect object information, based on beat signals mixed by the receiving channels,
the signal processing circuitry including
first processing circuitry to detect a position and a velocity of the object, based on the beat signals,
second processing circuitry to detect an azimuth angle of the object, based on the beat signals and results of processing by the first processing circuitry,
transmission phase control circuitry to modulate transmission phases of the transmission chirp signals with different degrees of modulation for the individual transmitting channels,
a memory to hold transmission phase reference values that are phase information of transmission signals, and
transmission phase correction circuitry to calculate amounts of change in the transmission phases, based on transmission phases in a spectrum obtained by the first processing circuitry and the transmission phase reference values held in the memory, wherein
the transmission phase control circuitry performs control to change the phases of the transmission chirp signals, based on the amounts of change in the transmission phases calculated by the transmission phase correction circuitry.

6. The radar apparatus according to claim 5, wherein
the radar apparatus includes a performance correction mode to correct performance of the radar apparatus,
in the performance correction mode, the plurality of receiving channels receive direct waves of the transmission chirp signals whose transmission phases have been modulated with the different degrees of modulation for the individual transmitting channels, and
the signal processing circuitry detects reception transmission phases of transmission direct wave components of all the transmitting channels in any one of the channels, calculates amounts of transmission phase change in all the transmitting channels, and reflects the calculated amounts of transmission phase change onto processing by the second processing circuitry.

7. The radar apparatus according to claim 1, wherein
the radar apparatus includes a failure detection mode to detect failure of the radar apparatus,
in the failure detection mode, the plurality of receiving channels receive direct waves of the transmission chirp signals whose transmission phases have been modulated with the different degrees of modulation for the individual transmitting channels,
the signal processing circuitry detects amplitudes of transmission direct wave components of all the transmitting channels in all the receiving channels, and
when at least one of the amplitudes of the transmission direct wave components of all the transmitting channels is less than or equal to a threshold, the radar apparatus determines that the radar apparatus is in failure.

8. A method of operating a radar apparatus performed using a radar apparatus including a plurality of transmitting channels to generate transmission chirp signals, and a plurality of receiving channels to receive reflected waves of the transmission chirp signals radiated from the transmitting channels and reflected at an object, and mix received signals using a reference signal on which the transmission chirp signals are based, to detect object information based on beat signals mixed by the receiving channels, the method comprising:
modulating transmission phases of the transmission chirp signals with different degrees of modulation for the individual transmitting channels;
simultaneously radiating the transmission chirp signals generated in the modulation from the plurality of transmitting channels into space;
receiving direct waves of the transmission chirp signals radiated in the radiation and detecting amplitudes of transmission direct wave components of all the transmitting channels in all the receiving channels; and
determining failure of the radar apparatus, based on results of comparisons between the amplitudes of the transmission direct wave components detected in the amplitude detection and a preset threshold.

9. The method of operating the radar apparatus according to claim 8, comprising:
receiving the direct waves of the transmission chirp signals radiated in the radiation and detecting reception phases of any one of the transmission direct wave components in all the receiving channels;
calculating amounts of reception phase change, based on detected values of the reception phases detected in the phase detection and reception phase reference values held in advance; and
reflecting the amounts of reception phase change calculated in the calculation onto processing to detect the object.

10. The method of operating the radar apparatus according to claim 8, comprising:
receiving the direct waves of the transmission chirp signals radiated in the radiation and detecting transmission amplitudes of the transmission direct wave components of all the transmitting channels in any one of the receiving channels;
calculating amounts of transmission amplitude change, based on detected values of the transmission amplitudes detected in the amplitude detection and transmission amplitude reference values held in advance; and
reflecting the amounts of transmission amplitude change calculated in the calculation onto amplitude control of the transmission chirp signals to be radiated in the radiation.

11. The method of operating the radar apparatus according to claim 8, comprising:
receiving the direct waves of the transmission chirp signals radiated in the radiation and detecting transmission phases of the transmission direct wave components of all the transmitting channels in any one of the receiving channels;
calculating amounts of transmission phase change, based on detected values of the transmission phases detected in the phase detection and transmission phase reference values held in advance; and
reflecting the amounts of transmission phase change calculated in the calculation onto phase control of the transmission chirp signals to be radiated in the radiation.

12. The radar apparatus according to claim 2, wherein
the radar apparatus includes a failure detection mode to detect failure of the radar apparatus,
in the failure detection mode, the plurality of receiving channels receive direct waves of the transmission chirp signals whose transmission phases have been modulated with the different degrees of modulation for the individual transmitting channels,
the signal processing circuitry detects amplitudes of transmission direct wave components of all the transmitting channels in all the receiving channels, and
when at least one of the amplitudes of the transmission direct wave components of all the transmitting channels is less than or equal to a threshold, the radar apparatus determines that the radar apparatus is in failure.

13. The radar apparatus according to claim 3, wherein
the radar apparatus includes a failure detection mode to detect failure of the radar apparatus,
in the failure detection mode, the plurality of receiving channels receive direct waves of the transmission chirp signals whose transmission phases have been modulated with the different degrees of modulation for the individual transmitting channels,
the signal processing circuitry detects amplitudes of transmission direct wave components of all the transmitting channels in all the receiving channels, and
when at least one of the amplitudes of the transmission direct wave components of all the transmitting channels is less than or equal to a threshold, the radar apparatus determines that the radar apparatus is in failure.

14. The radar apparatus according to claim 4, wherein
the radar apparatus includes a failure detection mode to detect failure of the radar apparatus,
in the failure detection mode, the plurality of receiving channels receive direct waves of the transmission chirp signals whose transmission phases have been modulated with the different degrees of modulation for the individual transmitting channels,
the signal processing circuitry detects amplitudes of transmission direct wave components of all the transmitting channels in all the receiving channels, and
when at least one of the amplitudes of the transmission direct wave components of all the transmitting channels is less than or equal to a threshold, the radar apparatus determines that the radar apparatus is in failure.

15. The radar apparatus according to claim 5, wherein
the radar apparatus includes a failure detection mode to detect failure of the radar apparatus,
in the failure detection mode, the plurality of receiving channels receive direct waves of the transmission chirp signals whose transmission phases have been modulated with the different degrees of modulation for the individual transmitting channels,
the signal processing circuitry detects amplitudes of transmission direct wave components of all the transmitting channels in all the receiving channels, and
when at least one of the amplitudes of the transmission direct wave components of all the transmitting channels is less than or equal to a threshold, the radar apparatus determines that the radar apparatus is in failure.

16. The radar apparatus according to claim 6, wherein
the radar apparatus includes a failure detection mode to detect failure of the radar apparatus,
in the failure detection mode, the plurality of receiving channels receive direct waves of the transmission chirp signals whose transmission phases have been modulated with the different degrees of modulation for the individual transmitting channels,
the signal processing circuitry detects amplitudes of transmission direct wave components of all the transmitting channels in all the receiving channels, and
when at least one of the amplitudes of the transmission direct wave components of all the transmitting channels is less than or equal to a threshold, the radar apparatus determines that the radar apparatus is in failure.
